(19) United States
(12) Patent Application Publication
(10) Pub. No.: US 2007/0254825 A1
(43) Pub. Date: Nov. 1, 2007

(54) Enhanced self-warming cleaning products

(76) Inventors: Thomas Gerard Shannon, Neenah, WI (US); Brian Patrick Argo, Hortonville, WI (US); Mary Rece Holt, Fremont, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/413,503

(22) Filed: Apr. 28, 2006

(51) Int. Cl. C11D 17/00

(52) U.S. Cl. 510/441

(57) ABSTRACT

Self-warming cleaning products, such as wet wipes, include a cleaning solution containing a nonionic surfactant having a cloud point from about 10° C. below to about 2° C. above the maximum temperature of the cleaning product during normal use. By incorporating such nonionic surfactants into the cleaning solution, the effectiveness of the cleaning solution can be enhanced.

### BACKGROUND OF THE INVENTION

Hand washing and other cleaning is essential to avoiding the spread of germs. Critical to disinfection capability is the ability to remove soil from the skin. Surfactants are commonly used to assist in removal of the soil and are key components in many soaps. Cleaning cloths and wipes may also contain small amounts of surfactants to assist in removal of soil. Surfactants can be anionic, cationic or nonionic. An advantage to nonionic surfactants is that they tend to be less irritating to mucosal membranes. Nonionic surfactants clean best when the temperature of the surfactant solution is near or slightly above the cloud point temperature of the surfactant solution. If the cloud point temperature of the surfactant solution is above ambient temperature, cleaning products containing nonionic surfactants which are not intended to be used in conjunction with hot water may be less effective at cleaning than products containing ionic surfactants. While some nonionic surfactant solutions may have cloud points below room temperature, cleaning solutions containing such surfactants can be unstable in the long term because there is a tendency for the nonionic surfactant to precipitate over time, which in turn reduces the cleaning effectiveness of the product. Thus, while these products may be less irritating, they may also be less effective at removing soil.

Therefore there is a need for cleaning products that are gentle, yet have improved cleaning in the absence of hot water and are stable for extended periods of time.

### SUMMARY OF THE INVENTION

The cleaning efficacy of self-warming cleaning products, such as wipes, soaps, detergents, etc., may be improved by incorporating a nonionic surfactant into the cleaning formulation such that the cloud point of the nonionic surfactant cleaning solution is equal to, or slightly lower than, the average maximum temperature achieved by the self-warming wiping product during use. The products of this invention can be used for personal cleansing, hard surface cleaning and/or other general wet cleaning tasks, particularly when a source of hot water is not be available.

Hence in one aspect, the invention resides in a self-warming cleaning product (such as wipes, soaps, solutions, lotions, etc.) comprising an aqueous cleaning solution containing a nonionic surfactant, wherein the cloud point of the solution containing the nonionic surfactant is from about 10° C. below to about 2° C. above the maximum temperature of the cleaning solution during normal use of the product. More specifically, the cloud point can be from about 5° C. below to about 2° C. above the maximum temperature of the cleaning solution during normal use of the product. Still more specifically, the cloud point can be from about 2° C. below to about 2° C. above the maximum temperature of the cleaning solution during normal use of the product. Alternatively, the cloud point can be from about 10° C. below to about the maximum temperature of the cleaning solution during normal use of the product. More specifically, the cloud point can be from about 5° C. below to about the maximum temperature of the cleaning solution during normal use of the product. Still more specifically, the cloud point can be from about 2° C. below to about the maximum temperature of the cleaning solution during normal use of the product.

As used herein, the “cloud point” of a nonionic surfactant solution is the temperature above which the nonionic surfactant becomes insoluble in the particular cleaning solution into which it is incorporated. The nonionic surfactants useful for purposes of this invention show an inverse solubility with increasing temperature. The cloud point can be measured in accordance with ASTM test method D2024 (ASTM D2024) for determining cloud point, which uses a 1% aqueous solution of the surfactant. However, since a variety of factors can influence the cloud point value, such as surfactant concentration and the presence of other chemicals, for purposes herein the cloud point must be determined using the particular cleaning solution in question, rather than a 1% aqueous solution, when carrying out the ASTM test procedure.

The cloud points of the selected surfactant solutions are preferably at least about 3° C. above room temperature (23° C.), but will depend upon the extent to which the temperature of the self-warming product is elevated during use. More particularly, the cloud point of the surfactant solution is preferably from about 26° C. to about 66° C., more specifically from about 26° C. to about 55° C., and still more specifically from about 27° C. to about 52° C.

As used herein, a “self-warming” product means that the product does not require an input of thermal energy to create an increase in the temperature of the product. Instead, heat is generated within the product by a chemical reaction that is triggered by an external stress or action applied to the product that enables the chemical reaction to take place. A wide variety of such heating technologies are well known in the art. Among these, most commonly, are temperature changes caused by oxidation or heat of solution.

As used herein, the “maximum temperature” of the product is the maximum temperature attained by the product once the thermal activation process has begun. In particular, the maximum temperature is determined by measuring the maximum temperature of the product after activation of the thermal heating process when the ambient temperature is between 22° C. and 23° C. The maximum temperature may be determined by first equilibrating the non-activated, self-heating product at a temperature between 22° C. and 23° C. for a period of 4 hours or more. The product is then activated to start the heat production process. The temperature of the product is recorded over time to determine the maximum temperature reached by the product. Alternatively, for commercially-available products, if specific instructions are provided with the product that specificy a specific or minimum time for which the product is to remain activated prior to use, in such instances the maximum temperature is the temperature of the product as measured at the specifically instructed or minimum time. Nevertheless, when using this method, the product should still be equilibrated at an ambient temperature of 22° C. to 23° C. for a minimum of 4 hours prior to determining the maximum temperature.

The maximum temperature reached by the activated product is not overly critical to the invention so long as the cloud point of the surfactant solution is as described above. However, by way of examples, the maximum temperature of the solution can be from about 26° C. to about 70° C., more specifically from about 27° C. to about 60° C., and still more specifically from about 28° C. to about 55° C. In cases where use of the product may contact the skin, it may be advantageous to limit the maximum temperature to about 55° C. or less to avoid the possibility of thermal burns.

### DETAILED DESCRIPTION OF THE INVENTION

A wide variety of nonionic surfactants can be used for purposes of this invention, provided the cloud point is selected properly. Examples of such nonionic surfactants include, but are not limited to, polyoxyethylene alkylamines, trialkylamine oxides, triethanol amine fatty acid esters and partial fatty acid esters, polyoxyethylene alkyl ethers such as those obtained by ethoxylation of long chain alcohols, polyoxyethylene alkenyl ethers, alkylphenyl ethoxylates, polyoxyethylene polystyriphenyl ethers, polypropylene glycol fatty acid esters and alkyl ethers, polyethylene glycol fatty acid esters and alkyl ethers, polyhydric alcohol fatty acid partial esters and alkyl ethers, glycerin fatty acid esters, polyglycerin fatty acid esters, polyoxyethylene polyhydric alcohol fatty acid partial esters and alkyl ethers, polyoxyethylene sorbitan fatty acid esters, polyoxyethylene glycerin fatty acid esters, polyoxyethylene fatty acid esters and alkyl ethers, polyglycerin fatty acid esters, ethoxylated/propoxylated vegetable oils and the like including mixtures of said surfactants.

More specifically, the nonionic surfactant may be selected from an alkoxylated material having the following formula:
R—X—(C₂H₄O)₄—C₂H₄—X—R′

wherein:

“R” and “R′” are selected from the group consisting of: hydrogen; primary, secondary, and branched chain alkyl and/or acyl hydrocarbyl groups; primary, secondary, and branched chain alkenyl hydrocarbyl groups; and primary, secondary, and branched chain alkyl- and alkenyl-substituted phenolic hydrocarbyl groups; wherein the hydrocarbyl groups having a hydrocarbyl chain length of from about 8 to about 20 carbon atoms;

“X” is selected from the group consisting of: O, C(O)O, C(O)N(R), and C(O) N(R)R′, wherein “R” and “R′” are as defined above; and

“z” is an integer of 1 or greater, preferably about 4 or greater.

In one specific embodiment, at least one of “R” and “R′” is a hydrocarbyl group having from about 8 to about 20 carbon atoms. In another specific embodiment, “R” is a hydrocarbyl group of from about 8 to about 20 carbon atoms and “X—R′” is OH.

In other embodiments, the nonionic surfactant may comprise a linear alkoxylated alcohol. Suitable linear alkoylated alcohols include, but are not limited to, the deca-undeca-, dodeca-, tetradaca- and pentadeca-ethoxylates of n-hexadecanol and n-octadecanol derivatives. Exemplary ethoxylated primary alcohols are CH₃(CH₂)₁₇O(C₂H₄O)₁₀OH and CH₃(CH₂)₉O(C₂H₄O)₁₁OH. In other embodiments the nonionic surfactant may include ethoxylates of mixed natural or synthetic alcohols. Examples of such materials include but is not limited to CH₃(CH₂)₁₇O- (C₂H₄O)₁₁OH, o CH₃(CH₂)₁₇O- (C₂H₄O)₁₈OH and CH₃(CH₂)₁₇O- (C₂H₄O)₂₅OH. Other linear alkoxylated alcohols include the deca-, undeca-, dodeca-, tetradeca-, pentadeca-, octadeca-, and nonadeca-ethoxylates of 3- hexadecanol, 2-octadecanol, 4-eicosanol, and 5-eicosanol. Exemplary alkoxylated secondary alcohols that can be used in the present invention include: (CH₃ (CH₂)₁₅)₂CHO(C₂H₄O)₁₁OH; (CH₃ (CH₂)₁₉)₂CHO(C₂H₄O)₁₁OH; and (CH₃ (CH₂)₁₅)₂CHO(C₂H₄O)₁₄OH. Linear alkyl phenoxylated alcohols that may be used in the present invention include the hexa-through octadecaethoxylates of alkylated phenols, particularly monohydric alkylphenols. Other examples of linear alkylphenoxylated alcohols include the hexa-through octadeca-ethoxylates of p- tridecylphenol, m-pentadecylphenol, and the like. Exemplary ethoxylated alkylphenols useful as wetting agents are p-tridecylphenol-(C₂H₄O)₁₁OH and p-pentadecylphenol-(C₂H₄O)₁₈OH.

Specific examples of suitable commercially available nonionic surfactants include polyglycol sufactants, such as Dowfax™ DF 62 and Dowfax™ 62LF manufactured and sold by Dow Chemical. These two nonionic surfactants have ASTM standard 1% aqueous cloud points of 32° C. and 29° C., respectively. Examples of other suitable nonionic surfactants includes, but are not limited to, Siponic™ NP-9 (Alcolac), Tergitol™ 15-S-7 and Tergitol™ 15-S-9 (Dow Chemical), all having ASTM standard 1% aqueous cloud points above 30° C.

The surfactant cleaning solution may also comprise ionic surfactants. In a specific embodiment, the nonionic surfactants may be combined with an N-acyl sarcosinate surfactant such that incorporation of the N-acyl sarcosinate causes an increase in the cloud point of the nonionic surfactant. For example, it has been shown that incorporation of 0.01% sodium lauroyl sarcosinate will increase the cloud point of the nonionic surfactant Alcodet™ MC-2000 (Rhodia) from about 20° C. to about 30° C.

Nonionic surfactants can also be blended with semi-polar nonionic or zwitterionic surfactants such as alkylamidoalkylene dialkylamine oxide, trialkylamine oxide and alkylamidoalkyldialalkylbetaines to produce low-irritant surfactant solutions. Nonionic surfactants can also be blended with anionic surfactants, such as linear alkyl sulfates and linear alkyl sulfonates, to boost cleaning at the cloud point as well. Such activity enables use of nonionic surfactants having cloud points below room temperature by increasing the cloud point of the surfactant in the given solution to insure no stability issues with storage of the products at elevated temperatures. Similar behavior is seen with other nonionic surfactants in the presence of the N-acyl sarcosinate. An example of N-acyl sarcosinates are the Hamposy® line of surfactants manufactured and sold by Chattem Chemical.

The performance of the cleaning solution used in the products of this invention may be enhanced by the presence of chelating agents. Chelating agents may improve the solubility and performance of the surfactant blends. Suitable chelating agents include citrates, EDTA salts, phosphates, silicates, and the like.

The specific technology used to self-heat the products of the present invention is not overly critical to the invention so long as the temperature requirements discussed above are met. A variety of technologies and containment configurations for preparing self heating products can be used. In one embodiment, for example, the self heating device may comprise a can or a similar container for holding the surfactant-containing solution and a self-contained assembly for heating the container and the material within it to a temperature above ambient. The self-contained assembly is isolated from the solution comprising the non-ionic surfactant such that there is no direct contact of the materials in the heating chamber with those of the solution comrpising the nonionic surfactant. For example, the container may consist of a standard metal can holding a quantity of a cleaning solution comprising the nonionic surfactant. A jacket or housing surrounds the can, with reagents for an exothermic temperature change reaction inside the jacket in proximity to the can. The device is activated by the user such that the reaction heats the can and its contents. In one embodiment, the reagent storage vessel holds a quantity of calcium oxide and a quantity of water, with a barrier between them to keep the two reagents separated. The device includes a mechanism for the user to activate the chemical reaction by breaching the barrier to allow the calcium oxide and water to mix. When this occurs, the resulting exothermic reaction generates heat that is transferred to the container to raise the temperature of the product inside the container. An example of such devices is described in US 2005/0051156 A1 to Schreff et al. entitled “Reagent Mixtures For Self-Contained Temperature-Change Container Assemblies” published Mar. 10, 2005, herein incorporated by reference.

In a similar embodiment, the self-heating of the product is generated just prior to use by an exothermic heat of solution reaction that occurs from mixing the aqueous solution comprising the nonionic surfactant and a material having an exothermic heat of solution. For example, the aqueous cleaning solution comprising the nonionic surfactant and a salt having an exothermic heat of reaction, such as magnesium chloride or calcium chloride, are isolated in two chambers seperated by a frangible seal. The two chambers may be located inside a pocket of a cleaning mitt or two layers of an absorbent substrate, such as a non-woven or tissue. Examples of suitable cleaning mitts are disclosed in commonly-assigned U.S. patent application Ser. No. 11/303,062 to Argo et al. filed Dec. 13, 2005 and entitled “Two-Sided Applicator With Reactive Or Complementary Chemistries”, which is hereby incorporated by reference. In use, the frangible seal between the salt and the cleaning solution comprising the nonionic surfactant is broken, thereby allowing the salt and the cleaning solution to mix. Upon mixing, the solution heats. The amount of salt and cleaning solution, as well as the nonionic surfactant, are selected such that the solution heats to near or slightly above the cloudpoint of the cleaning solution.

Alternatively, the heated solution can be released from the mixing chamber and be deposited into the absorbent substrate. The heated substrate can then be used as an enhanced cleaning article. Methods for preparing products comprising frangible seals and absorbent substrates are described in the art.

In another embodiment, the self-heating may be generated by microencapsulated heat delivery vehicles that can be effectively utilized in a wipe or similar product such that, upon use and activation, the contents of the microencapsulated heat delivery vehicles are released and contacted with moisture causing an exothermic warming of the product. In an embodiment the microencapsulated heat delivery vehicle may comprise an encapsulation layer that surrounds a core composition, wherein the core composition comprises a matrix material and a heating agent. Such technology and associated products utilizing this technology are disclosed in commonly-assigned U.S. patent application Ser. No. 11/319,881 to Abuto et al. filed Dec. 28, 2005 and entitled “Wipes Including Microencapsulated Delivery Vehicles and Processes of Producing the Same”, herein incorporated by reference.

In another embodiment, the invention comprises a liquid soap suitable for personal cleaning, such as hand washing. The liquid soap comprises the microencapsualted heat delivery vehicles described above and the nonionic surfactant solution. The amount of heat delivery vehicle in the soap and the nonionic surfactants are selected such that, when activated by the user, the soap solution warms to a temperature near or slightly above the cloudpoint of the soap solution comprising the non-ionic surfactant, thus enhancing the cleaning capability of the soap.

### EXAMPLES

### EXAMPLE 1

This example Ilustrates use of an exothermic salt in conjunction with a cleaning solution to prepare a heat-activated product in accordance with this invention. Specifically, the product comprises a dry wipe having a non-woven substrate impregnated with magnesium chloride or other salt having a high enthalpy of solution. The impregnated wipe is packaged in a manner such that it is located in an isolated chamber so that air or moisture is excluded from contacting the impregnated wipe during storage. An aqueous solution comprising the nonionic surfactant is packaged in a second isolated chamber adjacent to the chamber containing the impregnated wipe. A frangible seal is located between the first and second chambers. When the seal is broken by the user, the aqueous solution containing the surfactant flows into the wipe. The salt is dissolved in the surfactant solution and the temperature of the system increases due to the enthalpy of solution. The amount of salt and solution are selected such that the temperature reached by the mixed salt solution is between −2° C. and +10° C. of the cloud point of the mixed salt solution comprising the nonionic surfactant. The resulting warm wet wipe is then removed from the packaging and used to clean. Removal of the wipe may be facilitated by perforations around the chamber comprising the wipe or other means known in the art. Nonionic surfactants used in conjunction with a salt-based heating system may preferably have high cloud points, as the salt may cause a reduction in the cloud point temperature.

### EXAMPLE 2

A product similar to that in Example 1, except that the product comprises two isolated chambers surrounded by a wiping substrate. The chambers individually contain the salt and the aqueous surfactant solution. A frangible seal separates the salt and surfactant solutions, which are blended first. The blended solution is then released via either a simple pressure-rupturing mechanism or another frangible seal and into the wipe. The wipe is then removed for use.

### EXAMPLE 3

A general purpose cleaner for hard surfaces, rugs, upholstery, etc. comprises a cleaning solution containing the nonionic surfactant in a container such as a can. The container further comprises a heating chamber consisting of an isolated two component system. Such systems for heating liquids inside containers using chemical reactions are known in the art. Such devices, for example, may include a liquid container in proximity to a reagent storage vessel. The reagent storage vessel holds a quantity of calcium oxide and a quantity of water, with a barrier between the calcium chloride and water to keep the two reagents separated. The devices include a mechanism for breaching the barrier to allow the calcium oxide and water to mix. When this occurs, the resulting exothermic reaction generates heat that is transferred to the liquid inside the container causing the temperature of the product inside the container to increase. The amount of reagents and amount of liquid cleaning solution comprising the non-ionic surfactant are controlled such that the final temperature achieved by the cleaning solution is between −2° C. and +10° C. of the cloud point of the cleaning solution comprising the nonionic surfactant.

### EXAMPLE 4

This example provides a product containing a liquid soap or other liquid personal cleansing composition comprising a self-heating technology and a nonionic surfactant. When rubbed in the hands, the soap formulation generates heat such that the final temperature achieved by the soap solution is between −2° C. and +10° C. of the cloud point of the cleaning solution comprising the nonionic surfactant.

It will be appreciated that the foregoing examples, given for illustration, are not to be construed as limiting the scope of this invention, which is defined by the following claims and all equivalents thereto.

We claim:

1. A self-warming cleaning product in which the temperature of the product is elevated by an exothermic chemical reaction or heat of solution, said product comprising an aqueous cleaning solution containing a nonionic surfactant, wherein the cloud point of the solution containing the nonionic surfactant is from about 10° C. below to about 2° C. above the maximum temperature of the cleaning solution during normal use of the product.

2. The product of claim 1 wherein the cloud point of the solution comprising the nonionic surfactant is from about 5° C. below to about 2° C. above the maximum temperature of the cleaning solution during normal use of the product.

3. The product of claim 1 wherein the cloud point of the solution comprising the nonionic surfactant is from about 10 ° C. below to about 0° C. above the maximum temperature of the cleaning solution during normal use of the product.

4. The product of claim 1 wherein the cloud point of the nonionic surfactant solution is from about 26° C. to about 66° C.

5. The product of claim 1 wherein the cloud point of the nonionic surfactant solution is from about 26° C. to about 55° C.

6. The product of claim 1 wherein the cloud point of the nonionic surfactant solution is from about 30° C. to about 52° C.

7. The product of claim 1 comprising a tissue or nonwoven substrate and useful as a wipe.

8. The product of claim 1 further comprising an ionic surfactant which serves to elevate the cloud point of the cleaning solution.

9. The product of claim 1 wherein the aqueous cleaning solution further comprises N-acyl sarcosinate.

10. The product of claim 1 wherein the aqueous cleaning solution further comprises sodium lauroyl sarcosinate.

11. The product of claim 1 comprising a wiping substrate physically separated from the cleaning solution by a breakable or removable barrier, said wiping substrate containing a salt selected from the group consisting of calcium chloride and magnesium chloride, whereby upon breaking or removing the barrier, the cleaning solution permeates the wiping substrate and dissolves the salt(s), thereby heating the cleaning solution.

12. The product of claim 11 wherein the wiping substrate is in the form of a cleaning mitt.

13. The product of claim 11 wherein the cleaning solution is encapsulated in frangible capsules that break under hand pressure prior to or during use of the product.

14. The product of claim 1 wherein the product comprises a self heating device, the self heating device comprising a container for holding the nonionic surfactant-containing solution and a self-contained isolated assembly for heating the container and the surfactant containing solution wherein the heating reaction is activated by the user.

15. The product of claim 14 wherein the self-contained isolated assembly is a reagent vessel holding a quantity of calcium oxide and a quantity of water, with a barrier between them to keep the two reagents separated until activated by the user.

16. The product of claim 14 wherein the nonionic surfactant containing solution is a hard surface cleaner composition.

17. The product of claim 14 wherein the nonionic surfactant containing solution is a personal cleanser composition.

18. The product of claim 1 wherein the product is a liquid hand soap.

19. The product of claim 18 wherein the self warming is produced by a microencapsulated heat delivery vehicle, the microencapsulated heat delivery vehicle comprising an encapsulation layer that surrounds a core composition, wherein the core composition comprises a matrix material and a heating agent.

20. The product of claim 1 wherein the product is a wet wipe.

21. The product of claim 20 wherein the wet wipe comprises a microencapsulated heat delivery vehicle, the microencapsulated heat delivery vehicle comprising an encapsulation layer that surrounds a core composition, wherein the core composition comprises a matrix material and a heating agent.
